(19) United States
(12) Patent Application Publication
(10) Pub. No.: US 2014/0130645 A1
(43) Pub. Date: May 15, 2014

(54) CUTTING MACHINE AND EMERGENCY STOP METHOD OF MOTOR

(71) Applicants: Nobuhiro Takano, Hitachinaka (JP); Shigeharu Ushiwata, Hitachinaka (JP); Hiromi Ozawa, Hitachinaka (JP); Yoshikazu Kawano, Hitachinaka (JP)

(72) Inventors: Nobuhiro Takano, Hitachinaka (JP); Shigeharu Ushiwata, Hitachinaka (JP); Hiromi Ozawa, Hitachinaka (JP); Yoshikazu Kawano, Hitachinaka (JP)

(73) Assignee: HITACHI KOKI CO., LTD., Tokyo (JP)

(21) Appl. No.: 14/129,915

(22) PCT Filed: Aug. 8, 2012
(86) PCT No.: PCT/JP2012/005047

§ 371 Date: Dec. 27, 2013

(30) Foreign Application Priority Data
Sep. 27, 2011 (JP) 2011-210683

(51) Int. Cl. B26D 7/24; B27G 19/02; F16P 3/14

(52) U.S. Cl. CPC B26D 7/24; F16P 3/147; B27G 19/02
USPC 83/13; 83/58

(57) ABSTRACT

First, second and third sensors 11, 12 and 13 emit electromagnetic waves, receive electromagnetic waves emitted by the first, second and third sensors 11, 12 and 13 and reflected by an object 9 or electromagnetic wave emitted by the object 9 that received the electromagnetic waves emitted by the first, second and third sensors 11, 12 and 13, and specify distances between themselves and the object 9, respectively, based on time differences between emissions and receptions of the electromagnetic waves, and a control section 3 specifies three-dimensional coordinates of the object 9 based on the distances between the respective sensors 11, 12 and 13 and the object 9, determines whether or not the three-dimensional coordinate of the object 9 falls within a predetermined region and stops a motor when the three-dimensional coordinates of the object 9 falls within the region.

### TECHNICAL FIELD

The present invention relates to a cutting machine which drives a saw blade for cutting a workpiece by a motor and an emergency stop method of the motor in the cutting machine.

### BACKGROUND ART

Japanese Patent Application Laid-Open Publication No. 2010-023186 (Patent Literature 1) described below discloses a cutting machine which cuts a material to be cut being put on a table using a saw blade and which makes determination about whether or not the number of pixels representing a hand of an operator within an image exceeds a predetermined threshold to stop the rotation of the saw blade.

### CITATION LIST

### Patent Literature

PTL 1: Japanese Patent Application Laid-Open Publication No. 2010-023186

### SUMMARY OF INVENTION

### Technical Problem

In the technique described in Patent Literature 1, it becomes essential to shoot and process an image, so that there is room for improvement in view of simplification of a configuration and speed of image processing.

A preferred aim of the present invention is to provide a cutting machine which does not require shooting and processing of an image for emergency stopping of a motor, is less complicated when setting of a range for detecting an object and fast at processing regarding an image processing technique, and an emergency stop method of the motor.

### Solution to Problem

An aspect of the present invention is a cutting machine. The cutting machine having a saw blade which cuts a workpiece being supported on a stand section and a motor for driving the saw blade, the cutting machine comprising: a coordinate-specifying section specifying coordinates of an object; and a stopping section stopping rotation of the motor when the coordinates specified by the coordinate-specifying section satisfy a predetermined condition.

The coordinate-specifying section includes at least one sensor detecting a position of the object and the sensor may be at least positioned substantially on an extension line of the saw blade.

The at least one sensor may be positioned on both sides of the saw blade.

The coordinate-specifying section may measure distances from a plurality of different positions to the object to specify the coordinates of the object based on a measurement result.

The coordinate-specifying section may have a plurality of sensor sections arranged at different positions. The respective sensor sections may emit electromagnetic wave and receive electromagnetic wave emitted from the sensor sections and reflected by the object or electromagnetic wave emitted from an object that received the electromagnetic waves emitted by the sensor sections.

The coordinate-specifying section may have an emitting section which emits electromagnetic wave and a plurality of sensor sections which receive the electromagnetic wave emitted from the emitting section and reflected by the object or electromagnetic wave emitted from an object that received the electromagnetic wave emitted from the emitting section. The respective sensor sections may be arranged at different positions from one another.

The object may be electromagnetic wave reflecting body or an IC tag provided on a hand of a worker or a glove worn by the worker.

The respective sensor sections may specify distances between the sensor sections and the object based on electromagnetic waves received by the sensor sections.

The coordinate-specifying section may specify three-dimensional coordinates of the object.

The stopping section may stop rotation of the motor when the coordinates specified by the coordinate-specifying section are in a predetermined region.

An alarming section which generates alarm when rotation of the motor is stopped by the stopping section or before or after the stop may be further provided.

The saw blade may be a rim saw blade which is held in a state where a portion of a circumferential edge thereof is protruded from an upper face of the stand section, so that the workpiece may be cut by the saw blade by moving the workpiece on the upper face of the stand section.

The coordinate-specifying section may have sensors arranged on both sides of the saw blade on an upper face of the stand section.

Another aspect of the present invention is an emergency stop method of a motor.

This method is an emergency stop method of a motor in a cutting machine including a saw blade which cuts a workpiece supported on a stand section and a motor which drives the saw blade, including the steps of: emitting electromagnetic wave by a first sensor section and receiving electromagnetic wave emitted by the first sensor section and reflected by an object or electromagnetic wave emitted by the object that received the electromagnetic wave emitted by the first sensor section; emitting electromagnetic wave by a second sensor section located at a position different from the position of the first sensor section and receiving electromagnetic wave emitted by the second sensor section and reflected by the object or electromagnetic wave emitted by the object that received the electromagnetic wave emitted by the second sensor section; emitting electromagnetic wave by a third sensor section located at a position different from the positions of the first and the second sensor sections and receiving electromagnetic wave emitted by the third sensor section and reflected by the object or electromagnetic wave emitted by the object that received the electromagnetic wave emitted by the third sensor section; specifying distances between the respective first to third sensor sections and the object based on the electromagnetic waves received by the first to third sensor sections; and stopping rotation of the motor when coordinates representing the respective distances specified are in predetermined regions.

Incidentally, any combination of the above constituent elements and such a case where the expression of the present invention is replaced by a system or the like are also usable as aspects of the present invention.

### Advantageous Effects of Invention

According to the present invention, since a coordinate of an object is specified and rotation of the motor is stopped when the specified coordinate satisfies a predetermined condition, it is unnecessary to shoot and process an image for emergency stopping of the motor and complication in setting of a detection range for the object can be reduced. Particularly, since shooting and processing an image become unnecessary, a processing speed becomes fast so that a time required for motor stopping can be shortened.

### BRIEF DESCRIPTION OF DRAWINGS

FIG. 1 is a front external view of a cutting machine according to a first embodiment of the present invention.

FIG. 2 is a back external view of the cutting machine.

FIG. 3 is an illustrative external view of a cutting machine according to an embodiment of the present invention.

FIG. 4 is an explanatory diagram of a dangerous region in the cutting machine.

FIG. 5 is a functional block diagram of the cutting machine.

FIG. 6 is a flowchart of emergency stop of a motor in the cutting machine.

FIG. 7 is an illustrative external view of a working glove worn by a worker using the cutting machine.

FIG. 8 is an illustrative external view of an embodiment where three sensors are arranged on both sides of a face of a rim saw blade.

FIG. 9 is a functional block diagram of a cutting machine according to a second embodiment of the present invention.

FIG. 10 is a flowchart showing an operation of the second embodiment of the present invention.

FIG. 11 is an illustrative external view of a cutting machine according to a third embodiment of the present invention.

FIG. 12 is a functional block diagram of the cutting machine according the third embodiment.

FIG. 13 is a partially enlarged view of the cutting machine according the third embodiment illustrated in FIG. 11.

FIG. 14 is a perspective view of a desktop type cutting machine according to a fourth embodiment of the present invention.

### DESCRIPTION OF EMBODIMENTS

Preferred embodiments of the present invention will be described below with reference to the drawings. Incidentally, same or equivalent components, members, processes and the like illustrated in respective figures are attached with same reference signs and repetitive explanations thereof will be omitted properly. Further, the embodiments are not intended to limit the present invention and are merely examples, where all of features or any combination thereof described in the embodiments are not essential for the present invention necessarily.

### First Embodiment

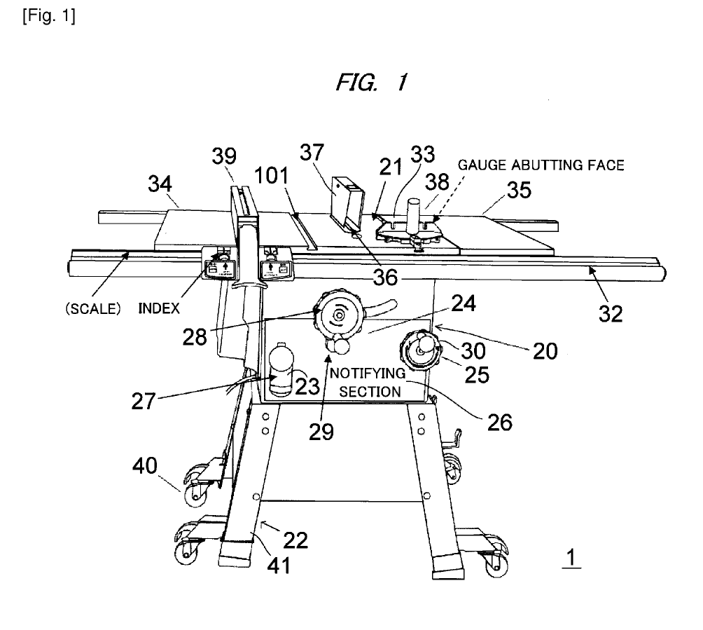

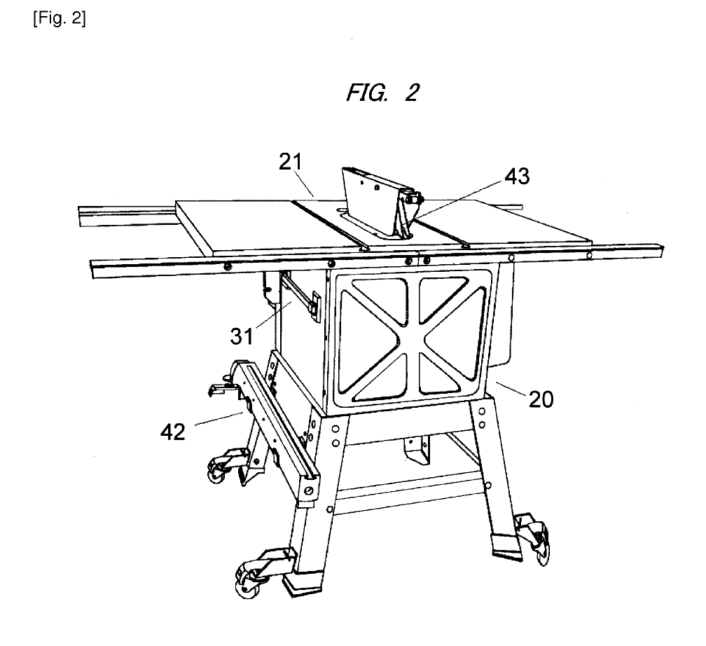

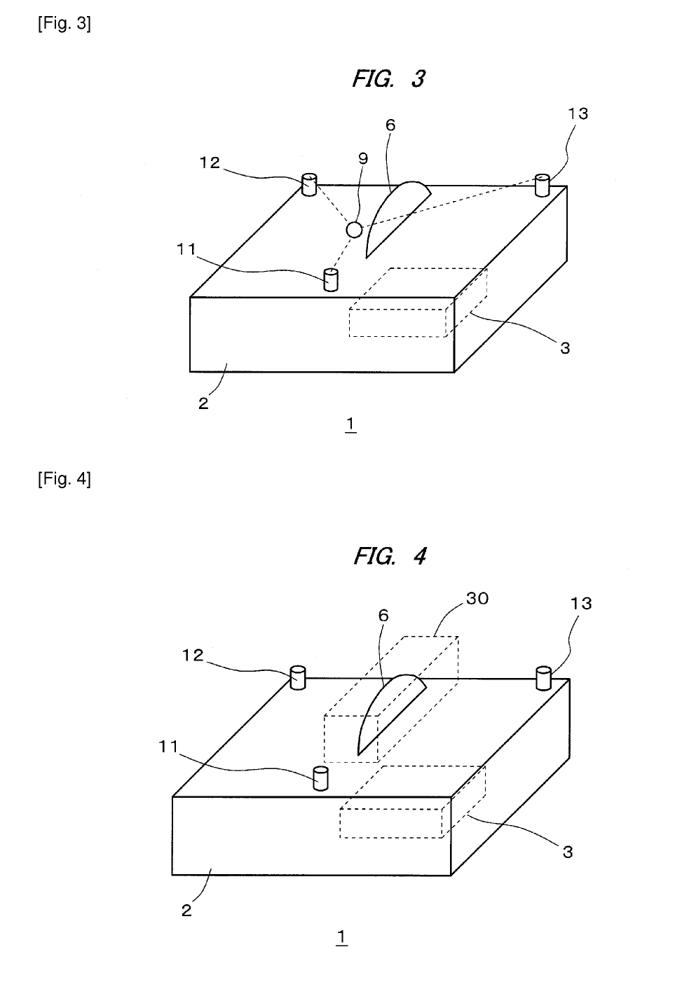

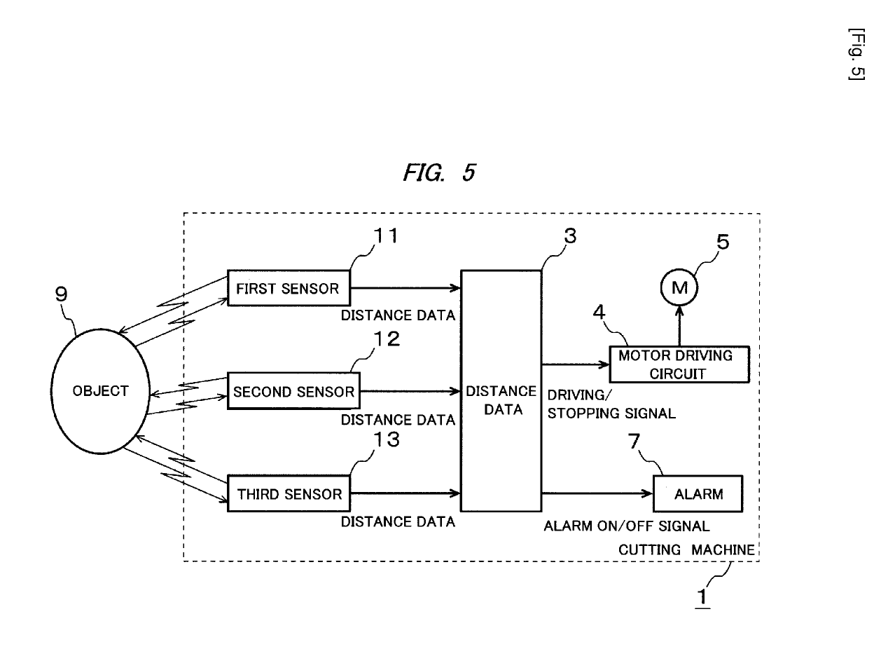

FIG. 1 is a front external view of a cutting machine 1 according to a first embodiment of the present invention. FIG. 2 is a back external view of the cutting machine 1. FIG. 3 is an illustrative external view of the cutting machine 1 according to the embodiment of the present invention. FIG. 4 is an explanatory diagram of a dangerous region 30 in the cutting machine 1. FIG. 5 is a functional block diagram of the cutting machine 1. The respective blocks illustrated in FIG. 5 are implemented by using hardware, software, or a combination thereof.

First of all, a structure and an operation of the cutting machine 1 according to the first embodiment of the present invention will be described. As illustrated in FIGS. 1 and 2, the cutting machine 1 is a so-called table saw, and is mainly composed of a main body section 20, a table section 21, and a stand section 22.

The main body section 20 incorporates a motor 5 and a control section 3 therein. Further, the main body section 20 is provided with a switch section 23 of the table saw 1, a rim saw blade adjusting section 24, an inclination adjusting section 25, and a notifying section 26 for performing notification of a driving state.

In the switch section 23, a power source switch is covered with a cover 27. The rim saw blade adjusting section 24 is for adjusting the position of the rim saw blade 6 in a vertical direction, namely, a projection amount of the rim saw blade 6 from an upper face of the table section 21 (an upper face of a table 33) described later, and is provided with a handle 28 and a lock lever 29. By rotating the handle 28 in one direction of left and right directions, the projection amount of the rim saw blade 6 from the upper face of the table section 21 can be adjusted. After the adjustment, a projection position is fixed by the lock lever 29. The inclination adjusting section 25 is for adjusting an inclination angle of the rim saw blade 6 relative to the upper face of the table section 21 and is provided with a handle 30. By rotating the handle 30 in one direction of left and right directions, the inclination angle can be adjusted. The notifying section 26 displays a driving state of the motor 5, the inclination angle, and the like in a digital manner, or displays them by blinking or lighting of LED, or the like. Alternatively, the notifying section 26 notifies a driving state of the motor 5, the inclination angle, and the like by buzzer, massage, and the like. Further, the notifying section 26 performs display or notification of an abnormal state described later when the abnormal state occurred. Further, a gauge housing section 31 housing a gauge therein is provided on a side face of the main body section 20.

The table section 21 is provided with a supporting section 32 attached to the main body section 20, the table 33 held by the supporting section 32, and extension tables 34 and 35 provided on the left and right sides of the table 33. The table 33 is provided with a saw blade through-hole 36 which allows the rim saw blade 6 to project beyond the upper face of the table 33 upward and a saw blade guard 37 which is positioned above the saw blade through-hole 36 and covers a circumferential edge and side faces of the rim saw blade 6 projecting from the upper face of the table 33. Further, a gauge 38 and a fence 39 for guiding a workpiece are provided on the upper face of the table 33. A splitting blade 43 which enters a cut portion of a workpiece which has been cut to split a workpiece into two pieces is provided behind the saw blade through-hole 36.

The gauge 38 is for moving a workpiece along a groove 101 provided in the table 33 when the workpiece is cut by the rim saw blade 6 while an abutting face of the gauge 38 is caused to abut on the workpiece. The gauge 38 is rotatable about a shaft (not shown) and is configured to be capable of adjusting the angle of the workpiece relative to the rim saw blade 6. That is, a cutting angle of the workpiece can be changed.

The fence 39 is supported by the supporting section 32 to be capable of moving along the supporting section 32. By changing the position of the fence 39, a distance between the rim saw blade 6 and an abutting face of the fence 39 is changed so that a cutting size of a workpiece can be adjusted. Further, a scale (not shown) is provided on the supporting section 32, so that a distance between the rim saw blade 6 and the fence 39 can be confirmed from an index provided on the fence 39.

The stand section 22 is composed of casters 40 for moving the table saw 1 and stands 41 attached with the casters 40 and supporting the main body section 20. The stands 41 are provided with a fence housing section 42 housing the above-described fence 39 therein. In FIG. 2, a state where the fence 39 is housed in the fence housing section 42 is shown.

The configuration of the table saw 1 is as described above, and the configuration of the table saw 1 is further described below in a simplified manner. The table saw 1 is provided with the stand section 2 (the main body section 20, the table section 21), and the rim saw blade 6 having a portion of a circumferential edge of which projecting from the upper face of the stand section 2. A worker arranges a workpiece such as wood on the upper face of the stand section 2 and slides the workpiece toward the rim saw blade 6 which is rotating, thereby cutting the workpiece by the rim saw blade 6. A configuration and an operation regarding an emergency stop of the rim saw blade 6 will be described below.

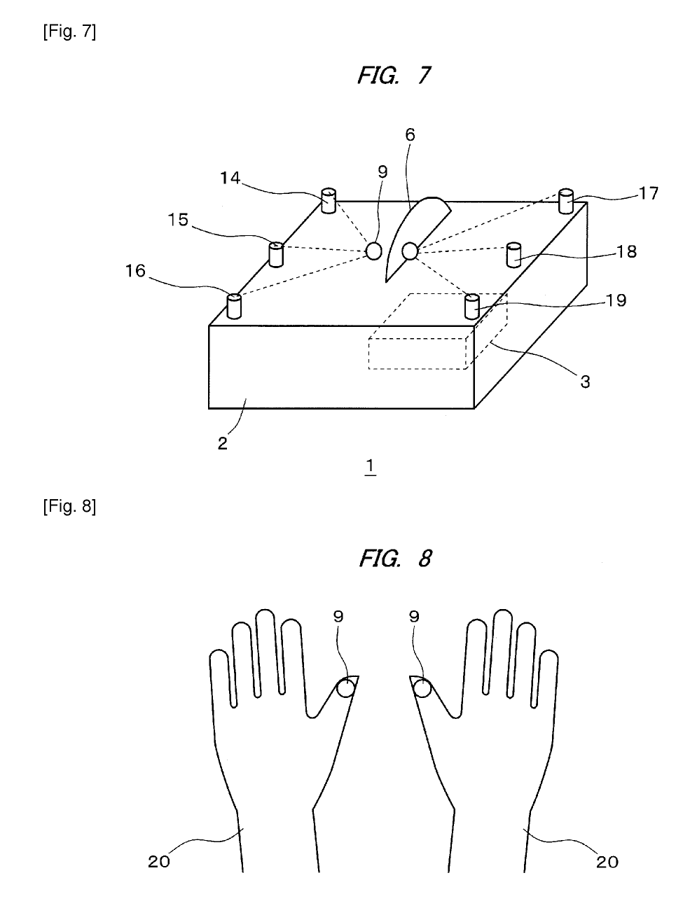

As illustrated in FIG. 5, the cutting machine 1 is provided with a first sensor 11, a second sensor 12, a third sensor 13, a control section 3, a motor driving circuit 4, the motor 5, and an alarm 7. The arrangement of the first sensor 11, the second sensor 12, and the third sensor 13 is as illustrated in FIG. 3, for example, and the respective sensors are fixed to the stand section 2. However, the arrangement positions of the respective sensors may be different from one another, and the sensor arrangement in the present invention is not limited to the arrangement illustrated in FIG. 3. The respective sensors include, for example, transmission and reception antennas fixedly provided on the stand section 2 and they have functions of emitting and receiving electromagnetic wave so that they can measure distances from them to the object 9. Frequencies of electromagnetic waves to be emitted may be different or the same for the respective sensors. Incidentally, the object 9 is electromagnetic wave reflecting body (for example, a metal body) or an IC tag (for example, an RF tag) attached to a distal end portion of a thumb of a working glove 20 worn by a worker, for example, as illustrated in FIG. 7. In addition, the IC tag may be a passive tag which does not store a battery therein. As illustrated in FIG. 4, a dangerous region 30 is preset in the vicinity of the rim saw blade 6, and the motor 5 brought to an emergency stop when the object 9 advances in the dangerous region 30, as described later. The control section 3 transmits a driving signal to the motor driving circuit 4 and the motor driving circuit 4 rotationally drives the motor 5. The rim saw blade 6 is rotationally driven according to rotation of the motor 5. The alarm 7 generates alarm such as sound or light to a worker when the alarm 7 is turned on by the control section 3.

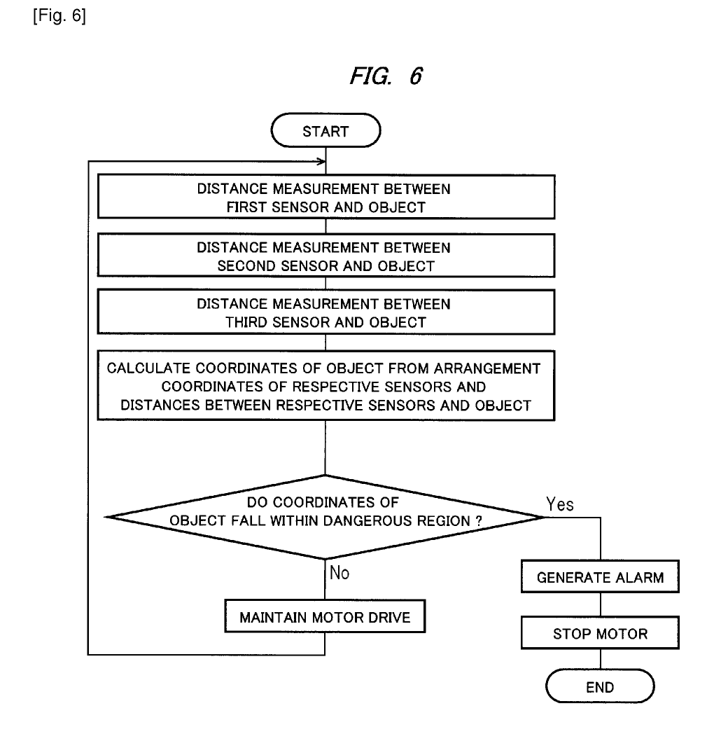

FIG. 6 is a flowchart of an emergency stop of the motor 5 in the cutting machine 1. Control starts from a state where the cutting machine 1 is powered on and the rim saw blade 6 is rotating (the motor 5 is rotating). The first sensor 11 measures a distance between itself and an object 9. Specifically, the first sensor 11 emits electromagnetic wave. When the object 9 is a metal body, the first sensor 11 receives electromagnetic wave emitted from the first sensor 11 and reflected by the object 9. When the object 9 is an IC tag, the first sensor 11 receives electromagnetic wave emitted by the object 9 that received the electromagnetic wave emitted by the first sensor 11 and which utilizes the electromagnetic wave emitted by the first sensor 11 as an energy source. The first sensor 11 measures (for example, calculates) the distance between itself and the object 9 based on a difference between emission and reception of the electromagnetic wave. A principle of the measurement is similar to that of radar. Subsequently, the second sensor 12 and the third sensor 13 measure distances between themselves and the object 9, respectively, like the first sensor 11.

For example, the control section 3 including a microcomputer receives distance data from the respective sensors and specifies (for example, calculates) a three-dimensional coordinate of the object 9 based on the distances between the respective sensors and the object 9. Subsequently, the control section 3 determines whether or not the three-dimensional coordinate of the object 9 falls within a predetermined dangerous region. Such a fact that the object 9 falls within the dangerous region here means that a thumb of a worker is close to the rim saw blade 6. The control section 3 maintains driving of the motor 5 (continues to feed a driving signal to the motor driving circuit 4) and maintains off state of the alarm 7 when the three-dimensional coordinate of the object 9 does not fall within the dangerous region. On the other hand, the control section 3 switches the alarm 7 to on state to generate alarm such as sound or light and stop the motor 5 (feed a stop signal to the motor driving circuit 4) when the three-dimensional coordinate of the object 9 falls within the dangerous region. Thereby, rotation of the rim saw blade 6 is stopped and a risk is reduced when the object 9 falls within the dangerous region 30.

The cutting machine 1 and the emergency stop method of the motor 5 in the cutting machine 1 according to this embodiment adopt such new configuration and approach that the three-dimensional coordinate of the object 9 is specified and the motor 5 is stopped when the specified coordinate falls within the dangerous region. In the cutting machine 1 and the emergency stop method of the motor 5 in the cutting machine 1 according to this embodiment, there is such a merit that shooting and processing an image are not required and such complexity that setting is performed in such a manner that a detection range does not fall within the dangerous range. Therefore, it can be said that the cutting machine 1 and the emergency stop method of the motor 5 in the cutting machine 1 according to this embodiment are excellent in cost, processing speed and ease for motor emergency stopping as compared with those in conventional art. Further, since the first sensor 11 is located on an extension line of the rim saw blade 6, an object (a hand of a person) can be reliably detected from the extension of the rim saw blade 6 when the hand of a person comes close to the rim saw blade 6.

Although the present invention has been described above based on the embodiment as an example, it should be understood by persons skilled in the art that the respective components or the respective processes of the embodiment may be modified or changed within a scope of claims. Modification examples will be described below.

Instead of emissions and receptions of electromagnetic waves by the sensors 11, 12 and 13, such a configuration can be adopted that emission of electromagnetic wave is performed by an emission section (either of the sensors 11, 12 and 13, or another sensor), and electromagnetic wave emitted by the emission section and reflected by the object 9 or electromagnetic wave emitted by the object 9 that received the electro- magnetic wave emitted by the emission section is received by the respective sensors 11, 12 and 13. In this case, the number of sensors for specifying the three-dimensional coordinate may be four or more.

Instead of the distal end portion of the thumb of the working glove 20 or in addition thereto, the object 9 may be provided on a distal end portion of another finger of the working glove 20. Further, the object 9 may be provided on another portion other than the distal end portion of the finger of the working glove 20. In addition, it is not essential to provide the object 9 on the working glove 20. For example, the object 9 may be worn on a finger or a wrist of a worker in a form of a ring or the like, or it may be attached to a predetermined position on a hand of a worker through a holder for the object 9.

As illustrated in FIG. 8, three sensors may be arranged on each of both sides of the rim saw blade 6. The respective sensors illustrated in FIG. 8 have the same function as the first sensor 11 illustrated in FIG. 3, for example. In this case, sensors 14, 15 and 16 are for detecting a left hand of a worker while sensors 17, 18 and 19 are for detecting a right hand of the worker. By adopting such a configuration, an object can be detected with higher precision than that in the case of the arrangement of sensors such as that illustrated in FIG. 3. That is, when the object 9 is located on one side (on the side of the second sensor 12 in FIG. 3) of the side faces of the rim saw blade 6, blocking of a transmission signal from the other side (the third sensor 13) by the rim saw blade 6 can be suppressed.

When the objects 9 are IC tags, one of the objects 9 provided on one of the working gloves 20 and the other of the objects 9 provided on the other of the working gloves 20 may emit electromagnetic waves having different frequencies from each other. Further, the glove 20 (the metal body or the IC tag) is illustrated as one example of the object 9, but such a configuration can be adopted that a special paint is directly applied to a human body (for example, a hand of a person) and the paint is detected by sensors so that distances from the sensors are calculated. In addition, a configuration for detecting a temperature distribution may be adopted. The rim saw blade and a cut portion of the workpiece become high temperatures due to friction between the rim saw blade and the workpiece during cutting of the workpiece. On the other hand, a person's body temperature is generally higher than temperature of the workpiece stored at normal temperature. Therefore, such a configuration can be adopted that distances from respective sensors to the rim saw blade are preliminarily stored in the control section and when another high temperature is detected within a predetermined region (the region 30) from the rim saw blade, the motor is stopped.

Note that, the projection amount of the rim saw blade 6 from the upper face of the stand section 2 and the inclination angle of the rim saw blade 6 relative to the upper face vary depending on a working situation. Therefore, when such a configuration is adopted that a worker stores the regions 30 corresponding to various working situations in a storage section in advance, and when the projection amount of the rim saw blade or the like is changed, the control section automatically selects an optimal region from the various regions stored in the storage section, a more effective result can be obtained. This configuration can be applied to all of the embodiments.

### Second Embodiment

The above-described embodiment and modified embodiments are directed to motor control corresponding to the coordinate of the object in the state where the motor is being rotationally driven. Specifically, a signal from the glove 9 (which incorporates a metal body, an IC tag or the like therein) worn by a worker is received by the first to third sensors 11 to 13 and distances (coordinates) are calculated in the control section 3. Therefore, when the worker does not wear the glove 9, coordinate calculation cannot be performed, so that even when a hand of the worker enters the region 30, the motor 5 continues to rotate.

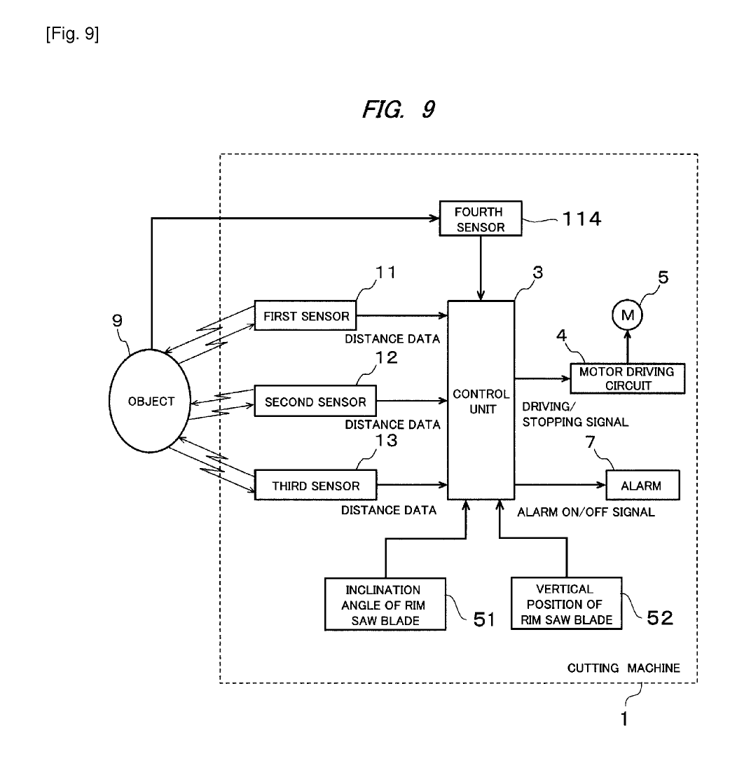

Therefore, the feature of the present embodiment lies in a state before rotational drive of the motor 5. As illustrated in FIG. 9, the cutting machine 1 is provided with a fourth sensor 114 in addition to the first sensor 11 to the third sensor 13. The fourth sensor 114 is a receiving means for receiving a signal from an object 9 (worker). When a signal from the object 9 (glove) cannot be received by the fourth sensor 114, drive of the motor 5 is forbidden. Further, the cutting machine 1 has an inclination angle sensor 51 which detects an inclination angle of the rim saw blade 6 to the upper face of the above-described stand section 2 (table) and a vertical-position sensor 52 which detects a vertical position of the rim saw blade 6 relative to the upper face of the stand section 2, and outputs (position information) from the respective sensors are fed to the control section 3.

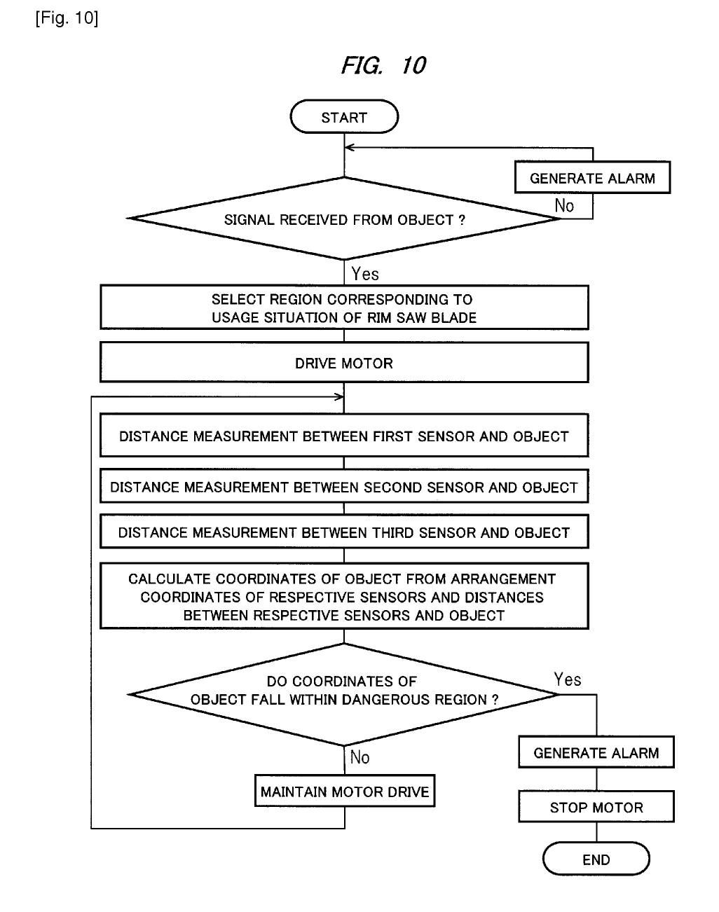

The present embodiment will be specifically described with reference to FIG. 10. The cutting machine 1 is connected to a commercial power supply to actuate the control section 3. The control section 3 starts a coordinate calculating processing of an object 9. The control section 3 determines whether or not the fourth sensor 114 received a signal from the object 9. That is, the control section 3 determines whether or not a worker has worn the glove 9. For example, the control section 3 can determine whether or not the worker operated a motor driving switch in a state where he/she has worn the glove 9. When the fourth senor 114 does not receive a signal from the glove 9, the control section 3 generates alarm and repeats this process until the worker wears the glove 9. As the alarm, there is display of alarm message or voice guidance.

When the control section 3 receives a signal from the glove 9, it selects a dangerous region 30 corresponding to a usage situation of the rim saw blade 9 from the storage section incorporated in the control section 3. The coordinates of the dangerous regions 30 corresponding to a plurality of usage situations are stored in the storage section in advance. Thereafter, the control section 3 outputs a motor driving signal to the motor driving circuit 4 to start rotational drive of the motor 5. Since the processing performed thereafter is the same as that in the first embodiment described above, repetitive descriptions thereof are omitted. Incidentally, in selection of the dangerous region 30, the control section 3 may automatically read the projection amount of the rim saw blade 6 from the stand section 2 and the inclination angle, and the worker may select the dangerous region manually.

### Third Embodiment

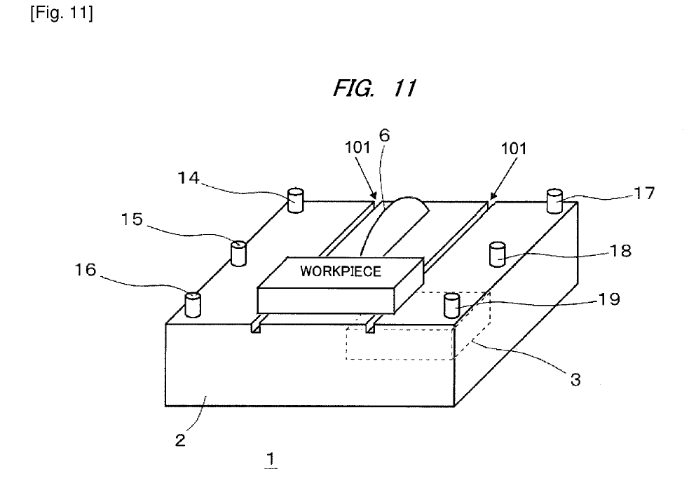

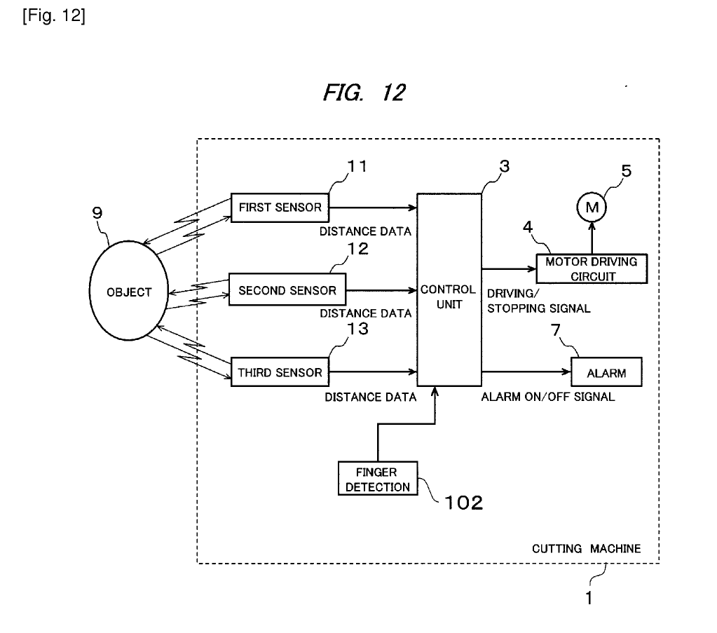

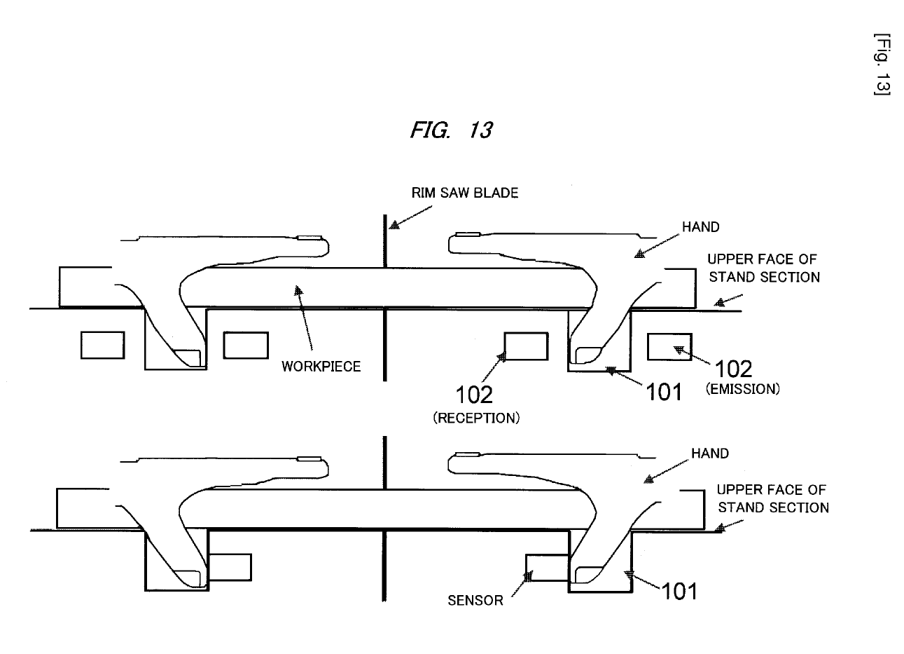

In the above-described embodiments, the coordinates of an object are detected by three sensors and whether or not the detected coordinates fall within the dangerous region 30 is determined. The object is the glove 9 worn by a worker, and especially, a signal-generating body (a metal body, an IC tag) is attached to a thumb of the glove 9. The feature of the present embodiment, as illustrated in FIGS. 11 to 13, lies in that a finger detecting section 102 which detects whether or not a finger is positioned within a groove 101 for guiding the above-described gauge 38, which is provided on the stand section 2 (table) is provided. Incidentally, the finger detecting section 102 may be provided in a groove other than the groove 101 for guiding the gauge. As illustrated in FIGS. 13A and 13B, for example, the finger detecting section 102 is composed of a signal emitting section and a signal receiving section, and whether or not a signal (for example, light) from the signal emitting section is blocked is detected (FIG. 13A). Alternatively, the finger detecting section 102 emits a signal in a state where it is pressed (FIG. 13B). The finger detecting section 102 can be embedded at any position (may be embedded over a whole length) within the groove 101 and any number of the finger detecting sections 102 may be embedded within the groove 101.

In the present embodiment, the motor 5 can be driven only in the state where a finger (thumb) of a worker is positioned within the groove 101. When cutting a workpiece, a worker puts his/her thumb within the groove 101. When the worker slides the workpiece toward the rim saw blade 6 (toward a depth side of a sheet of the drawing), he/she moves his/her thumb together with the workpiece along the groove 101. The movement of the thumb is always detected by the finger detecting section 102, and the motor 5 is controlled by the control section 3 based on the detection signal. When the control section 3 determines that the thumb is not positioned within the groove 101 from the detection signal, it generates alarm to stop drive of the motor 5 or forbid drive of the motor 5 before start of the drive. On the other hand, when the control section 3 determines that the thumb is positioned within the groove 101 from the detection signal, it outputs a drive signal to the motor driving circuit 4 to start drive of the motor 5. Here, if the position of the groove 101 relative to the rim saw blade 6 is set in such a state that the thumb of a worker is positioned within the groove 101, his/her remaining fingers do not reach the rim saw blade 6, he/she is not required to wear a glove or the like.

It is preferable to achieve a further effect that determination about whether or not a worker has worn the glove is also made in the same manner as the above-described second embodiment. In this case, the signal-generating body of the glove is eventually attached to another place other than the thumb of the glove, so that further effect can be achieved by grasping the position of the object based on both the coordinate of the signal-generating body and the position of the thumb. Further, such a configuration can be adopted that a sensor is provided on the gauge 38, so that the motor 5 is driven only when one hand of a worker holds the gauge 38 and the other hand is positioned within the groove 101.

### Fourth Embodiment

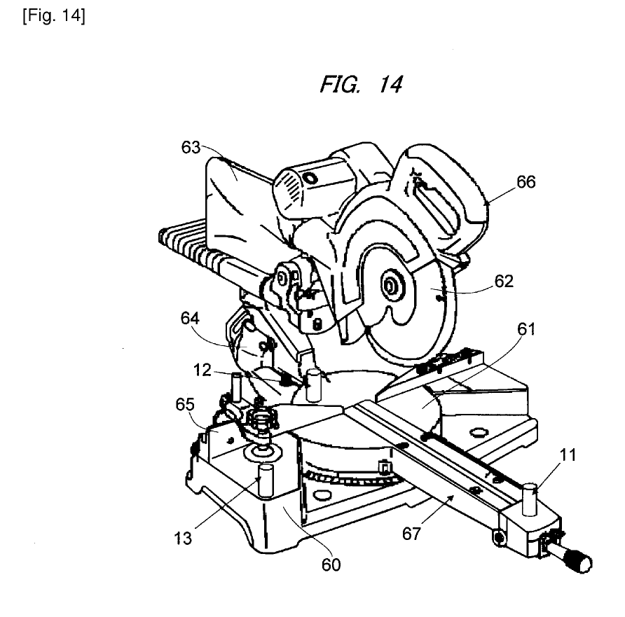

The cutting machine 1 in the above-described embodiments has been the table saw, but the present invention can be applied to a desktop-type cutting machine such as that illustrated in FIG. 14. The desktop type cutting machine is composed of a base 60 and a turntable 61 rotatably supported by the base 60, and is provided with a base section on which a workpiece is put, a cutting section 63 rotatably supporting a rim saw blade 62, and a supporting section 64 supporting the cutting section 63 so as to come close to and separate from the base portion. The base 60 is provided with a fence 65 supporting a workpiece. Further, the cutting section 63 is provided with a handle 66 grasped by a worker.

In this embodiment, three sensors 11 to 13 for detecting the position of an object are provided on a neck portion 67 of the turntable 61, on a rear side of the fence 65 of the turntable 61, and on the base 60. Here, it is necessary for a worker to grasp the handle 66 to swing the cutting section 63 downward (toward the base section) during cutting work. That is, since the worker always grasps the handle 66 with his/her one hand (for example, the right hand), there is hardly a possibility that the one hand comes close to the rim saw blade 62. Therefore, the other hand (for example, the left hand shown on the left side in the figure) has a possibility that it enters the dangerous region. In this embodiment, therefore, three coordinate-detecting sensors 11 to 13 are arranged on the left side of the rim saw blade 62. Incidentally, the sensors may be arranged on the left and right sides regarding the rim saw blade 62, and they may be provided on the cutting section 63 or the supporting section 64.

1. A cutting machine including a saw blade that cuts a workpiece being supported on a stand section and a motor for driving the saw blade, the cutting machine comprising:
a coordinate-specifying section specifying coordinates of an object; and
a stopping section stopping rotation of the motor when the coordinates specified by the coordinate-specifying section satisfy a predetermined condition.

2. The cutting machine according to claim 1,
wherein the coordinate-specifying section includes at least one sensor detecting a position of the object and the sensor is at least positioned substantially on an extension line of the saw blade.

3. The cutting machine according to claim 1,
wherein the coordinate-specifying section includes at least two sensors detecting a position of the object and the sensors positioned on both sides of the saw blade.

4. The cutting machine according to claim 1,
wherein the coordinate-specifying section measures distances from a plurality of different positions to the object to specify the coordinates of the object based on a measurement result.

5. The cutting machine according to claim 1,
wherein the coordinate-specifying section has a plurality of sensor sections arranged at different positions, and
the respective sensor sections emit electromagnetic waves and receive electromagnetic waves emitted from the sensor sections and reflected by the object or electromagnetic wave emitted from an object that received the electromagnetic waves emitted by the sensor sections.

6. The cutting machine according to claim 1,
wherein the coordinate-specifying section has an emitting section emitting electromagnetic wave and a plurality of sensor sections receiving the electromagnetic wave emitted from the emitting section and reflected by the object or electromagnetic wave emitted from an object that received the electromagnetic wave emitted from the emitting section, the respective sensor sections being arranged at different positions from one another.

7. The cutting machine according to claim 5,
wherein the object is electromagnetic wave reflecting body or an IC tag provided on a hand of a worker or a glove worn by the worker.

8. The cutting machine according to claim 6,
wherein the object is electromagnetic wave reflecting body or an IC tag provided on a hand of a worker or a glove worn by the worker.

9. The cutting machine according to claim 5,
wherein the respective sensor sections specify distances between the sensor sections and the object based on electromagnetic waves received by the sensor sections.

10. The cutting machine according to claim 1,
wherein the coordinate-specifying section specifies three-dimensional coordinates of the object.

11. The cutting machine according to claim 1,
wherein the stopping section stops rotation of the motor when the coordinates specified by the coordinate-specifying section are in a predetermined region.

12. The cutting machine according to claim 1, further comprising an alarming section which generates alarm when rotation of the motor is stopped by the stopping section or before or after the stop.

13. The cutting machine according to claim 1,
wherein the saw blade is a rim saw blade which is held in a state where a portion of a circumferential edge of the saw blade is protruded from an upper face of the stand section, so that the workpiece is cut by the saw blade by moving the workpiece on the upper face of the stand section.

14. The cutting machine according to claim 13,
wherein the coordinate-specifying section has sensors arranged on both sides of the saw blade on an upper face of the stand section.

15. An emergency stop method of a motor in a cutting machine including a saw blade that cuts a workpiece supported on a stand section and a motor that drives the saw blade, the emergency stop method comprising the steps of:
emitting electromagnetic wave by a first sensor section and receiving electromagnetic wave emitted by the first sensor section and reflected by an object or electromagnetic wave emitted by the object that received the electromagnetic wave emitted by the first sensor section;
emitting electromagnetic wave by a second sensor section located at a position different from the position of the first sensor section and receiving electromagnetic wave emitted by the second sensor section and reflected by the object or electromagnetic wave emitted by the object that received the electromagnetic wave emitted by the second sensor section;
emitting electromagnetic wave by a third sensor section located at a position different from the positions of the first and the second sensor sections and receiving electromagnetic wave emitted by the third sensor section and reflected by the object or electromagnetic wave emitted by the object that received the electromagnetic wave emitted by the third sensor section;
specifying distances between the respective first to third sensor sections and the object based on the electromagnetic waves received by the first to third sensor sections; and
stopping rotation of the motor when coordinates representing the respective distances specified are in predetermined regions.
